(19) United States
(12) Patent Application Publication
(10) Pub. No.: US 2014/0280188 A1
(43) Pub. Date: Sep. 18, 2014

(54) System And Method For Tagging Filenames To Support Association Of Information

(71) Applicant: PERFORCE SOFTWARE, INC., Alameda, CA (US)

(72) Inventors: Christopher D. Seiwald, Alameda, CA (US); Alan H. Teague, Alameda, CA (US); Billie M. Mandel, Oakland, CA (US)

(73) Assignee: Perforce Software, Inc., Alameda, CA (US)

(21) Appl. No.: 13/842,528

(22) Filed: Mar. 15, 2013

(51) Int. Cl. G06F 17/30

(52) U.S. Cl. CPC G06F 17/30321
USPC 707/741

(57) ABSTRACT

A system and methods to associate information with a file are described. A system including memory, one or more processors, and one or more modules stored in memory and configured for execution by the one or more processors. The system including a unique identifier determination module configured to determine a unique identifier of a file. Further, the system includes an index management module configure to lookup a unique identifier. In addition, the system includes a tag generating configured to generate a tag based on a filename. And, the system includes a tagging module configured to associate the tag with the file.

### FIELD

Embodiments of the invention relate to file identification. In particular, embodiments of the invention relate to a system and methods to identify a file based on a unique identifier.

### BACKGROUND

There are many useful applications which can be built if a system can associate extra information with a given file. Digital watermarking is an approach for associating information with a file. This technique involves changing the contents of a file in some way to embed associated information in the file. However, many types of documents cannot be changed in this way without damaging the contents. In addition, the amount of information that can be associated with files, for files that can be changed, is limited both by the type of file as well as by the size of the file.

### SUMMARY

A system and methods to associate information with a file are described. A system including memory, one or more processors, and one or more modules stored in memory and configured for execution by the one or more processors. The system including a unique identifier determination module configured to determine a unique identifier of a file. Further, the system includes an index management module configure to lookup a unique identifier. In addition, the system includes a tag generating configured to generate a tag based on a filename. And, the system includes a tagging module configured to associate the tag with the file.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a system to associate information with a file according to an embodiment;

FIG. 2 illustrates a block diagram of a distributed system according to an embodiment;

FIG. 3 illustrates a flow diagram for tagging a filename according to an embodiment;

FIG. 4 illustrates a flow diagram for interpreting a tagged filename according to an embodiment;

FIG. 5 illustrates a flow diagram for generating a tag according to an embodiment; and

FIG. 6 illustrates a block diagram of a system according to an embodiment.

### DETAILED DESCRIPTION

Embodiments of a system and methods for tagging filenames to support association of information with a file are described. An embodiment of a system associates information to a file using a unique identifier. Such a system uses a unique identifier that is generated based on a filename and is used to reference information associated with a file. The amount of information associate with a file, according to embodiments, is not limited by filename size constraints. Further, embodiments can associate information to a file without damaging or changing the contents of a file.

In addition, a system and methods according to embodiments described herein overcome problems associates with adding information to a filename. Specifically, adding information to a filename can make these names long and unwieldy for use. There are also some systems that limit length of a filename that as a result limit the amount of information that can be associated with a file. Embodiments according to those described herein, overcome such limitations by using a unique identifier to associate information with a file.

FIG. 1 illustrates a block diagram of an embodiment of a system to associate information to a file according to an embodiment. For an embodiment system 102 may be a computer, a server, a tablet, a smart phone, a user device or other device configured to associate information with a file. The embodiment illustrated in FIG. 1 includes a unique identifier determination module 104. For an embodiment, a unique identifier determination module 104 is coupled with an index management module 108. The unique identifier determination module 104, according to an embodiment, is configured to determine a unique identifier of a file. A unique identifier determination module 104 may determine a unique identifier based on a filename.

A filename may include, but is not limited to, a name and a file extension. A file extension may include, but is not limited to, doc, docx, xls, xlsx, pps, ppt, pptx, sdd, shw, txt, pdf, html, xhtml, mhtml, mht, xht, htm, dot, dotx, odt, ott, pdax, rtf, wpd, wpt, wrd, wri, xhtml, xml, ods, ots, wk1, wk3, wk4, wks, wq1, xlsb, xlsm, xlsb, xltm, xlw, and other designations indicating a format or a type of a file. Additionally, in an embodiment, a filename may be just the base name of the file, or it may be the base name of the file annotated with information about the file. A file extension or type, according to an embodiment, is an annotation. By way of example and not limitation, “readme” may be a base name for a file and “readme.txt” is a base name annotated with the type.

In an embodiment, a unique identifier determination module 104 is configured to determine a unique identifier based on a filename by parsing the filename to determine if a filename includes one or more delimiters. A delimiter includes, but is not limited to, one or more characters, an empty string, or other identifier. In response to determining a filename includes one or more delimiters, a unique identifier determination module 104 determines that a file includes a unique identifier. A unique identifier, according to an embodiment, includes a filename and a tag or a filename specific unique identifier. According to an embodiment, a tag creates a unique identifier in association with a filename. For such an embodiment, the same tag may be used with files having different filenames to create a unique identifier among a set of file, where some of the files in the set include the same filename. In an embodiment, a unique identifier includes a filename, a tag, and one or more delimiters. A tag includes, but is not limited to, an alphanumeric string and a numerical string. A tag may be a zero-length string. In an embodiment, a tag is a string including four alphanumeric or numeric characters. Another embodiment includes a tag including five alphanumeric or numeric characters. A tag may also include an empty string. A tag, according to an embodiment, may be a string that varies the number of characters in the string based on operating characteristics of a system including, but not limited to, size of an index, number of files managed by a system, a number of user of a system, and filename size constraints. One skilled in the art would understand a tag may include any number of characters.

According to an embodiment, a unique identifier determination module 104 sends a unique identifier to an index management module 108. An index management module 108 is configured to receive a unique identifier of a file. In response to receiving a unique identifier of a file, the index management module 108 is configured to retrieve information associated with a file based on the unique identifier. In an embodiment, an index management module 108 retrieves information associated with a file from an index, such as an associated information index. An index includes, but is not limited to a file, an array, a table, and or other data structure. An associated information index, according to an embodiment, is configured to include associated information for a file. In an embodiment, an associated information index includes one or more sets of associated information where each set of associated information is associated to a specific file. A set of associated information that corresponds with or is associated with a specific file may be linked, referenced or otherwise tagged to indicate that the information is associated with the specific file. In an embodiment, an index management module 108 is coupled with one or more databases 114 used to store an index. An index management module 108 may be coupled with a database 114 through a communication interface 112.

In an embodiment, an index management module 108 retrieves information associated with a file by sending a request to a communication interface 112. A request may include, but is not limited to, a unique identifier, an address, a row number, a column number or other reference. In response to receiving a request, a communication interface 112 is configured to access one or more locations in an associated information index stored in a database 114 based on a received request to retrieve information associated with a file. According to an embodiment communication interface module 112 is configured to receive and to retrieve information from one or more databases 114. An embodiment includes a communication interface 112 configured to access and/or retrieve information from an associated information index, for example, in a memory, a database, or an external server. Similarly, an embodiment includes a communication interface 112 configured to store information in an associated information index, for example, in a memory, a database, or an external server.

According to an embodiment, an index management module 108 is configured to lookup a unique identifier if a tag is not found in a filename. An index management module 108 may lookup or access a unique identifier by searching for a filename and/or associated information of a file in an associated information index. In an embodiment, an index management module 108 is configured to receive associated information of a file in a request from a unique identifier determination module 104.

In an embodiment, a unique identifier determination module 104 is configured to send a determined filename and/or associated information of a file to an index management module 108 in response to determining a file does not include a unique identifier. An index management module 108 is configured to receive a filename and/or associated information of a file. In response to receiving a filename and/or associated information of a file, the index management module is configured to lookup a unique identifier in an associated information index. According to an embodiment, an index management module 108 is configured to lookup a unique identifier by searching for a filename and/or associated information of a file in an associated information index. An index management module 108, according to an embodiment, is configured to lookup a unique identifier by comparing a filename and/or associated information of a file to those stored in an associated information index. In an embodiment, an index management module 108 is configured to lookup a unique identifier by sending a request for a lookup to a communication interface 112. In turn, a communication interface 112 is configured to retrieve a unique identifier using techniques including those describe herein.

As illustrated in FIG. 1, an index management module 108 is coupled with a tag generator 106. According to an embodiment, an index management module 108 is configured to request that a unique identifier be generated if the index management module 108 does not find a unique identifier for a file in an associated information index. A tag generator 106 is configured to generate a tag in response to receiving a request. A request may be of a type including those described herein. In an embodiment, an index management module 108 is configured to send a request, such as those described herein, for a tag if a lookup based on a filename and/or associated information fails.

A tag generator 106, according to an embodiment, is configured to generate a tag based on a filename. In an embodiment, a tag generator 106 is configured to generate a tag reference or access an increment index using a filename. A tag generator 106 retrieves an increment index corresponding to a received filename. An increment index indicates the last tag generated for a file having the received filename. A tag generator 106, according to an embodiment, is configured to increment a value in an increment index to a next value to generate a tag.

In an embodiment, a tag generator 106, is configured to generate a tag that is unique with respect to a received filename that is not a next value in a sequence. By way of example, and not limitation, a tag generator 106 may use a pseudorandom generator to generate a tag that is unique for that filename and is not used for any other file with the same filename. In an embodiment, an increment index is part of an associated information index. An increment index may be of a type and stored similar to an associated information index. An increment index, according to an embodiment, is separate from an associated information index. A tag generator 106 is configured to access an increment index using techniques similar to those described herein with regard to an associated information index.

The embodiment illustrated in FIG. 1 includes a tagging module 110 coupled with a tag generator 106. In an embodiment, a tag generator 106 is configured to send a tag to a tagging module 110. A tagging module 110 is configured to associate a tag with a file by appending a received tag to a filename of a file, according to an embodiment. A tagging module 110 is configured to append a tag to a filename by adding one or more delimiters and a tag to a filename. According to an embodiment, a delimiter is a zero-length string. In an embodiment, a tagging module 110 appends a tag to a filename by inserting a tag after a name in a filename with a first delimiter between the tag and the name and a second delimiter between a tag and a file extension to generate a unique identifier. For a filename that includes a name without a file extension, a tagging module 110 is configured to append a tag to a filename by inserting a tag after the name with a delimiter between the tag and the name to generate a unique identifier.

In an embodiment, a tagging module 110 is configured to store a generated unique identifier in an associated information index using techniques including those described herein. In an embodiment, a tagging module 110 is configured to update an increment index to include a generated tag corresponding to a filename. A tagging module 110 may also be configured to store information associated with a file using a generated unique identifier. Associated information or information associated with a file includes, but is not limited to, a filename type, a size of file, location information, a version of file, a history, a date created, created by, retrieved for, and retrieved data. Location information may include, but is not limited to, one or more of a computer name, a directory, a folder, an Internet Protocol address, or other information that identifies one or more of where a file is stored, where a file is accessed from, and where a file sent from.

According to an embodiment, a tagging module 110 is coupled with an index management module 108. In an embodiment, a tagging module 110 is configured to send a generated unique identifier to an index management module 108. In response to receiving a generated unique identifier, an index management module 108 is configured to store the unique identifier in an index that includes a plurality of information associated with a plurality of files using techniques including those described herein. An index management module 110 may also be configured to store information associated with a file in an associated information index using techniques including those described herein.

FIG. 2 illustrates a block diagram of a distributed system of an embodiment of a system 202 to associate information to a file. For an embodiment system 202 may be configured to operate as a server in a client-server relationship. For another embodiment system 202 may be configured to operate in a peer-to-peer relationship with one or more peers over a communication network 204. Yet another embodiment includes a system 202 coupled with one or more modules of the system over a communication network 204. A communication network 204 includes, but is not limited to, a wide area network (“WAN”), such as the Internet, a local area network (“LAN”), wireless network, or other type of network. According to embodiments, one or more devices 203 may be in communication with system 202 through a communication network 204. Devices 203 include, but are not limited to, a user device, a server, an external database, a peer, or other device that includes one or more modules configured to performing part or all of methods to associate information with a file or to receive results of a system configured to associate information with a file.

According the embodiment of the system 202 illustrated in FIG. 2, an embodiment of a device 203 that includes one or more a database(s) 216 coupled with a communication interface 218. A database 216 for an embodiment may be configured to store an index, an increment index, and/or associated information. A communication interface 206, 218, according to an embodiment, is configured to manage communication through a communication network 204 using communication protocols. For some embodiments, communication interface 206 in a system 202 manages one or more communication sessions between a system 202 and one or more devices 203. A communication interface 206, 218 may also convert or package data or information into the appropriate communication protocol depending on the protocol used by a device 203. According to some embodiments, a communication interface 206, 218 may be configured to use one or more communication protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other protocol.

The embodiment of a system 202 as illustrated in FIG. 2, in addition to a communication interface 206, includes a unique identifier determination module 208, a tag generator 210, an index management module 212, and a tagging module 214 and optionally one or more databases 220. These modules are coupled with each other and configured to associate information to a file such as using similar techniques as those described herein.

FIG. 3 illustrates a flow diagram for tagging a filename according to an embodiment. An embodiment of a method determines a unique identifier of a file, at block 302 in FIG. 3, using techniques including those described herein. If no unique identifier is associated with a file, at block 304, a method generates a tag using techniques including those described herein. At block 306, a method associates a tag with a file. In an embodiment, a method associates a tag with a file by appending a tag to a filename to form a unique identifier. At block 308, the method updates an associated information index with a unique identifier. In an embodiment, a method updates an index with a unique identifier by storing the unique identifier in the associated information index using techniques including those described herein.

FIG. 4 illustrates a flow diagram for interpreting a unique identifier or tagged filename according to an embodiment. At block 402, a file is received with a unique identifier. A method, at block 404, searches an associated information index for a tagged filename. In an embodiment, a method searches an associated information index for a unique identifier using techniques including those described herein. In response to finding the tagged filename, as illustrated at 406, the method retrieves associated information or information associated with a file using techniques including those described herein.

FIG. 5 illustrates a flow diagram for generating a tag according to an embodiment. At 502, a request is received for a tag. In an embodiment, a request may be received using techniques including those described herein. As illustrated at block 504 in FIG. 5, a method generates a tag based on a filename. According to an embodiment, a method generates a tag based on a filename using techniques including those described herein. At block 506, a method appends a tag to a file. In an embodiment a method appends a tag to a file using techniques including those described herein.

FIG. 6 illustrates an embodiment of system 602 that may be implemented as a client, server, a peer or other device that implements the methods described herein. The system 602, according to an embodiment, includes one or more processing units (CPUs) 604, one or more network or other communication interfaces 607, memory 614, and one or more communication buses 606 for interconnecting these components. The system 602 may optionally include a user interface 608 comprising a display device 610, a keyboard 612, touchscreen 613, and/or other input/output devices. Memory 614 may include high speed random access memory and may also include non-volatile memory, such as one or more magnetic or optical storage disks. The memory 614 may include mass storage that is remotely located from CPUs 604. Moreover, memory 614, or alternatively one or more storage devices (e.g., one or more nonvolatile storage devices) within memory 614, includes a computer readable storage medium. The memory 614 may store the following elements, or a subset or superset of such elements:

an operating system 616 that includes procedures for handling various basic system services and for performing hardware dependent tasks;

a network communication module 618 (or instructions) that is used for connecting the system 602 to other computers, clients, peers, systems or devices via the one or more communication network interfaces 607 and one or more communication networks, such as the Internet, other wide area networks, local area networks, metropolitan area networks, and other type of networks;

an application 619 including, but not limited to, a web browser, a document viewer or other application for viewing information;

a webpage 620 for indicating results, status of the method, or providing an interface for user feedback for the method as described herein;

an unique identifier determination module 622 (or instructions) for determining a unique identifier of a file as described herein;

a tag generator 624 (or instructions) for generating a tag as described herein;

an index management module 626 (or instructions) for receiving a unique identifier, retrieving information associated with a file based on an identifier, looking up a unique identifier, requesting a unique identifier be generated as described herein;

a tagging module 628 (or instructions) for associating a tag with a file including appending a tag to a filename as described herein;

an associated information index 630 as described herein; and

an increment index 632 as described herein.

Although FIG. 6 illustrates system 602 as a computer that could be a client and/or a server system, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 6 could be implemented on a single server or client and single items could be implemented by one or more servers or clients. The actual number of servers, client, or modules used to implement a system 602 and how features are allocated among them will vary from one implementation to another, and may depend in part on the amount of data traffic that the system must handle during peak usage periods as well as during average usage periods. In addition, some modules or functions of modules illustrated in FIG. 6 may be implemented on one or more systems remotely located from other systems that implement other modules or functions of modules illustrated in FIG. 6.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system to associate information with a file comprising:
memory;
one or more processors; and
one or more modules stored in memory and configured for execution by the one or more processors, the modules comprising:
a unique identifier determination module configured to determine an unique identifier of a file;
an index management module configure to lookup a unique identifier;
a tag generator configured to generate a tag based on a filename; and
a tagging module configured to associate said tag with said file.

2. The system of claim 1, wherein said tagging module associates said tag with said file by appending said tag to a filename of said file.

3. The system of claim 2, wherein appending said tag to said filename includes adding one or more delimiters to said filename.

4. The system of claim 1, wherein said filename includes a base name and a file extension.

5. The system of claim 1, wherein said file generator generates a tag based on a filename by accessing an increment index using said filename to retrieve an increment index for said file.

6. A method for associating information with a file comprising:
at one or more systems including one or more processors and memory:
determining a unique identifier of a file;
in response not determining said unique identifier, generate a tag based on a filename of said file;
associating said tag with said file to generate said unique identifier; and
updating an index with said unique identifier.

7. The method of claim 6, wherein associating said tag with said file includes appending said tag to a filename of said file.

8. The system of claim 7, wherein appending said tag to said filename includes adding one or more delimiters to said filename.

9. The system of claim 1, wherein said filename includes a base name and a file extension.

10. The system of claim 1, wherein generating a tag based on a filename includes accessing an increment index using said filename to retrieve an increment index for said file.

11. A method for associating information with a file comprising:
at one or more systems including one or more processors and memory:
receiving a file with a unique identifier;
searching an index for said unique identifier; and
retrieving associated information based on said unique identifier.

12. The method of claim 11, wherein said unique identifier includes a tag and a filename.

13. The method of claim 11, wherein said associated information includes location information.

14. The method of claim 12, wherein said tag includes a delimiter.

15. The system of claim 12, wherein said filename includes a base name and a file extension.
